(19) United States
(12) Patent Application Publication
(10) Pub. No.: US 2004/0230559 A1
(43) Pub. Date: Nov. 18, 2004

(54) Information processing device and information processing method

(76) Inventors: Mark Newman, New York, NY (US); Moshe Barnes, Tenafly, NJ (US)

Correspondence Address: KENYON & KENYON, ONE BROADWAY, NEW YORK, NY, 10004, US

(21) Appl. No.: 10/811,283

(22) Filed: Mar. 26, 2004

Related U.S. Application Data
(63) Continuation of application No. 09/634,747, filed on Aug. 9, 2000, now abandoned.
(60) Provisional application No. 60/148,082, filed on Aug. 9, 1999.
(60) Provisional application No. 60/148,082, filed on Aug. 9, 1999.

(51) Int. Cl. G06F 7/00

(52) U.S. Cl. 707/1

(57) ABSTRACT

An information processing system includes a multi-layer architecture between a data store and a user interface. The architecture includes a persistence layer configured to communicate with the data store, a domain layer configured to communicate with the data store via the persistence layer, a business object layer configured to communicate with the domain object layer, a controller layer configured to manage the system's control flow, and an adapter layer configured to mediate between the user interface and the business-object and controller layers. An information processing method includes the steps of retrieving a portion of data stored in a data store and storing the retrieved data in at least one domain object, retrieving at least a portion of the data stored in the domain object and storing the data retrieved from the domain object in at least one business object, and processing the data stored in the business object.

### CROSS REFERENCE TO RELATED APPLICATIONS

This application claims the benefit of U.S. Provisional Application No. 60/148,082, filed Aug. 9, 1999.

### BACKGROUND INFORMATION

As is known in the art, there is a trend to provide software systems which typically include databases and which utilize object-oriented programming techniques. The databases are typically stored in a data server. Thus the data server acts as a storage area for the data during the execution of an application as well as in the period between applications when the data is not processed. Some of the objects, often referred to as “business objects,” provide a way to combine data with software code in the working storage of the application server or client in order to view, use, or modify the data.

During operation of such systems there typically exists at any one time one or more objects which include information or data and program logic or functions. In such systems, the objects map data to the storage area (i.e., the database) as they are created and/or destroyed. A mechanism, often referred to as the “persistence layer,” queries data from the database given some request data, and builds one or more business objects from the data returned from the database. If an object is newly created during an invocation of an application, the persistence layer inserts the new object's data into the database. If an object exists prior to an invocation of an application but is modified during that invocation, the persistence layer updates the data in the database to reflect the changes. If a previously existing object is deleted during the invocation, the persistence layer updates the database to reflect the deletion.

One problem with this approach, however, is that it is time consuming and computationally expensive to repeatedly retrieve information from storage devices each time objects are created and destroyed. It is also time consuming to retrieve information for each business object individually, since then the retrieval of each object's information requires a separate interaction with the database, often also involving a separate sequence of messages over the network connecting the application to the database.

One solution to this problem is to use a so-called “data cache” approach. In this approach, objects access the database for data prior to the time the data is actually required. Such an approach is described in an article entitled Object Persistence: Beyond Serialization, Timo Salo, Justin Hill, Scot Rich, Chuck Bridgham and Daniel Berg published in Dr. Dobb's Journal, May 1999. This article describes a so-called “data extractor” which pre-fetches data from a database and identifies duplicate entries of information. The system subsequently stores the information as single entries accessible by any object that requires the information. The data extractor is a data cache that stores information in a manner that facilitates the step of building objects that requires the information. Data caches designed this way do not deal with the semantics of the applications they support. Because they ignore the meaning of the information that is retrieved, they forgo many opportunities to cache information in sets conforming more to the pattern of usage of the information. Another problem that arises in processing systems is the treatment of the same data that is used or processed by different objects. In some systems, the objects do not share the data. Rather the data are stored separately by each object. This results in the storage of duplicate data. Other systems utilize transaction mechanisms that prevent data from being accessed or modified unless the integrity of an update to the data can be ensured. Systems utilizing the separate storage-or transition mechanism approaches, however, fail to provide integration of data for multiple processing by separate objects.

A third problem is that data in a database is meant to be accessed by several applications and application invocations simultaneously. This means that the same data may be used for objects in different invocations at the same time. When data is used or changed by one invocation at the same time it is changed by another, there is potential for invalid or conflicting information to be captured in the database. To prevent this, some transaction mechanisms need to insure that the database remains consistent.

In the state of the art, transaction mechanisms are used by each object individually (or by the persistence layer for the object) as it attempts to update the database. This creates problems because system users typically expect that all of the work they do in an invocation will be applied in its totality to the database. Since earlier work may already have been updated in the database when some object's update fails, applying transaction mechanisms this way breaks the system user's “logical unit of work” during the invocation of the application.

The common aspect of these problems is that although the objects making use of database information are used within the same application invocation, there is insufficient coordination between them. Because each object interacts with the database independently, the integrated nature of the information—as it is stored in the database and as it is thought of by the users of information systems—is broken.

It would, therefore, be desirable to provide a system that allows rapid manipulation of data by multiple objects, that is computationally efficient and that provides integration of data for multiple processing by separate objects. It would also be desirable to provide a system which puts into practical application the notion of a “logical unit of work” (i.e., a working set of information used concurrently within an application, efficiently extracted in combination from data sources, manipulated using some common services by the business objects presenting packaged versions of the information to the rest of the application software, and providing common facilities for validating the information before it is returned to the persistent data sources).

### SUMMARY

This invention is comprised of four distinct but interlocking innovations:

1. A new architecture for business software applications.

2. A new high-level design language for specifying business software applications organized according to the aforementioned architecture.

3. A compiler for the aforementioned design language that compiles specifications to a third-generation programming language such as Java or Smalltalk.

4. A rich and extensible library of business concepts captured in the aforementioned language.

Together, these four innovations constitute a complete platform for the rapid development of business applications that can integrate easily with each other and with existing applications. The platform also provides for the creation of business-niche-specific frameworks that allow faster development of new applications for that niche. Complex business applications can be fully developed in significantly less time and using significantly fewer developers than would be required with prior art techniques.

Our new architecture for business software applications is organized into seven software layers: the data-store (a.k.a., database) layer, the persistence layer, the domain layer, the business-object layer, the controller layer, the adapter layer, and the user-interface layer. The data-store and user-interface layers are industry-standard layers, typically corresponding to a relational databases and some type of graphical user interface, respectively. The other layers are situated in between these two (in roughly the order they're listed above).

We will begin with a discussion of the domain layer, as it forms the core conceptual platform on which business applications are built. It is situated between the persistence layer and the business-object layer, and it provides transaction mechanisms to insure that data integrity is preserved. The domain layer includes a plurality of domain objects having stored therein data accessed from a data store via the persistence layer. The data store may be provided, for example, as a relational database. Domain objects contain a duplicate of a subset of the information in the data store. Each domain object, however, contains data that are unique to that object and thus no duplicate data is contained in the domain layer. Data stored in the domain objects corresponds to data utilized by business objects in accomplishing functions for a user. Domain objects thus perform the function of a “conceptual cache” for the data used by an application. This cache is conceptual because the classes defining the domain layer provide an object model of the business that is reusable among multiple applications in the business.

In this architecture, the function of business objects is to:

1. extract information from the domain and reorganize it in a structure amenable to further processing and/or presentation to a user via some interface as part of a specific application,

2. provide a set of primitives for manipulating the data they have extracted, including the ability to set values, create new information, delete existing information, recalculate dependent values (as in the functionality provided by spreadsheets), and change the presentation format in response to computational state, and

3. provide functionality for updating the domain based on the subset of the domain from which the business-object information was originally extracted and the manipulations that have been performed on the business objects.

Domain objects serve as an interface between business objects and a data store. Thus the domain objects eliminate the need for the business objects to map data to the storage area (i.e., the data store) as the business objects are created and/or destroyed. Systems using the domain-object approach are therefore able to process data more rapidly, efficiently and with less code than prior art systems since the domain object approach: (1) minimizes the need for time consuming and computationally expensive retrieval of data from storage devices each time business objects are created and destroyed; (2) provides for the validation of business information in a reusable library of software; and (3) provides automatic services within each application for coordination between the business objects, such as mechanisms for business objects to refresh themselves when underlying data has changed, or providing synchronization points within the application to which the application can be returned upon developer or user request. Domain objects thus interact with both business objects and the data store (via the persistence layer).

Additionally, domain objects perform a variety of functions involving the manipulation of data and the safeguarding of data consistency. These functions include but are not limited to providing a guarantee that information stored in and retrieved from a data store is valid (e.g., that the information is accurate and complete), performing computations to calculate derived information, enforcing rules to ensure that the data satisfies business requirements, and packaging “low-level” data manipulation.

An example of such data manipulation would be that when a single object is created, it would in turn create several more objects to hold data it requires for completeness. Instead of creating all the objects in every sequence of code that needs to create the first object, each such sequence might only create the first object, which itself will then always create the other objects it needs. Another example would be that when an object is first created, default values for the data it contains could be set. A third example would be that some data attributes might have lists of acceptable values associated with them. The attributes may only be valid if set to one of the acceptable associated values. Domain objects contain additional data and code to present these lists of values and to validate that the relevant data attributes are set to values taken from the associated lists.

To guarantee that the information stored to and retrieved from a data store is valid, a domain object may use a set of rules at the attribute level (e.g., the value of this attribute must be “red,” “green,” or “blue”) or at a higher level (e.g., each customer must have at least one home address).

The packaging of low-level data manipulation makes it easier to maintain data integrity. For example, an application that captures claim information might represent the driver of a damaged vehicle, an injured party, the claimant, and the insured in separate locations in the user interface (using multiple business objects), yet the same person might play all of these roles simultaneously. If the name of the person, or his address, is changed in one place in the interface, we want the change to propagate to all of these representations. Changing a value in the user interface changes the business object associated with that part of the interface. The change may be saved to the domain objects holding the information from which the business object was built (and not directly to the data store). Using built-in mechanisms, the domain informs other dependent business objects that underlying data has changed and that they may wish to refresh themselves. If the developer has chosen this option, the other business objects, and thus the other user interface locations associated with those business objects, will update themselves automatically. The domain thus provides a unifying point for coordinating and maintaining the consistency of multiple copies of the same application information that exists in the business-object layer.

The controller layer is a procedural control mechanism that manages the processing of information in the object-oriented business model. It consists of a plurality of controllers organized into groups corresponding to the business application's logical units of work (discussed earlier). Each of these controllers includes a state machine, and it interacts with up to three other layers: the domain layer, the business-object layer, and the adapter layer. The controller layer manages the timing of data flow between the domain and data-store layers (via the persistence layer) and between the domain and business-object layers, and it processes requests from the user interface (via the adapter layer). The processing between two persists of a domain to a data store encapsulates the concept of a “logical unit of work”.

The final piece of our application architecture, the adapter layer, decouples the business-object layer from the interface used to display information to the user of the application. This decoupling allows different interface technologies—GUI windows, HTML pages, etc.—to be used without any change to the business-object layer. The adapter layer includes a plurality of adapter objects, each of which manages the interaction between a business object (or an attribute of a business object or a collection of business objects) and an interface component (such as a Java Swing component). The adapter copies information from the business object (or objects) to the interface component, and when the business application user makes changes to the interface component, it copies information back to the business object.

One important step to building a business information system in accordance with the present invention's application architecture is to identify and provide libraries of domain classes with appropriate data structures and member functions. When properly designed, these libraries can be reused over and over again, acting as the foundation on which all applications for an organization can be built, and providing a central location where all changes to the organization's core business data and processes should be reflected. The design of domain-class libraries typically parallels the design of tables for a relational database, except that domain classes augment the “flat” relational structure with inheritance relationships and context-specific validation and processing rules. Appropriately selected, augmented and modified domain classes provide the ability to model a business in a desired manner with significantly less application-specific coding.

This need to model a business's data motivates the present invention's second innovation, a high-level design language for specifying business software applications. This formal specification language for business information covers all aspects of business system design, including:

1. database designs, queries, and transactions,

2. interfaces to external other systems,

3. validation of business information,

4. structures for building relationships among business information,

5. business objects allowing capture and manipulation of business information,

6. business process and application control flow, and

7. user interfaces and API integration.

The language is used to capture what processing is desired, and the business compiler (this invention's third innovation) renders the captured design into a programming language such as Java, Smalltalk, or C++ (in the preferred embodiment, the target language is Java). This provides significant additional coding efficiency since a small number of design decisions captured at the design level in the language can be compiled to many more lines of code in the implementation language.

The high-level designs, as captured using the design language, are a powerful differentiator between the present innovation and prior art techniques for building software business applications. The language formalism restricts the designer to a much smaller design space but preserves the flexibility to design any desired business-object behavior, which dramatically increases the efficiency of the design and implementation process. Furthermore, by capturing most design decisions in metadata, significantly fewer mistakes can be made and those that are made can be tracked and fixed more easily.

The design language is not “yet another new programming language” to be learned but rather the first formal specification language at the abstraction level of business system design. This specification language can be compiled into an implementation language like Java much in the way that Java is compiled into the byte code that can be run on a Java Virtual Machine.

The specification language is segregated into three parts: declaration, selection and manipulation. The first part of the language is its declarative syntax: how to specify new types (a.k.a, classes), features of those types, and relationships between types. To do this in our environment requires no more than entry in data fields, selection from drop downs and tables, clicking of radio buttons and so forth, in a purely graphical environment.

A good fraction of business functionality, especially what people often call “business objects” is nothing more than an arrangement configured to assemble information from various sources, manipulate it via well-specified rules, and save the manipulated information back to the original sources and perhaps some new locations. In the present innovation's terminology, selection refers to the extraction and packaging of data from the domain layer. To specify selection, the language uses a superset of the industry-standard Object Query Language (OQL). This superset allows developers/designers to use an SQL-like syntax to specify from where they wish to assemble information and the rules to manipulate the assembled information. It also provides a mechanism for declaring business-object classes based on the structure of an OQL query.

In the state of the art, OQL is a functional programming language for describing queries that extract and manipulate information from objects whose structure has been previously described to the OQL processing system. The result of an OQL query may be any datatype, i.e., an instance of any class previously described to the OQL processing system. An OQL query has no side effects; that is, the query makes no changes to any objects existing prior to the query's execution. OQL makes no provision for how a query's results can be used by other application code, or how to specify allowable manipulations of query results when the query has finished execution, or how the domain might be subsequently modified under some specified conditions resulting from the query's existence. The design language included in the present invention incorporates OQL as a way to describe efficiently queries of domain objects to build business objects, and also to describe efficiently queries of domain objects to describe domain-object properties and rules. Many other features of the design language describe how the OQL results are used in the various contexts in which they appear.

For manipulation, we use a subset of the Java programming language. The design language adopts the syntax of Java to minimize the burden of learning new syntax, but it restricts that Java so that no additional classes or manipulations other than those conforming to the architecture described herein can be specified using the syntax.

The fourth and final innovation of this invention is a library of business concepts specified in the design language. As anyone who has designed business information systems is well aware, much of the data used in a particular business application is generic data used in many business applications. For example, it is very common for business applications to include objects representing business parties (individuals and organizations) and addresses (street addresses, telephone numbers, URLs, etc.). Rather that requiring developers to design new business party and address objects for every application that's built, we provide standard business-party and address domain objects specified in the design language. Moreover, if these standard domain objects don't suffice for a particular application, they are extensible/customizable (through inheritance). Our library consists of both industry-independent business concepts and industry-specific concepts (such as insurance policies and claims). By providing a starting point for the design of a business application, these libraries further accelerate the business-application development process.

### BRIEF DESCRIPTION OF THE DRAWINGS

The foregoing features of this invention, as well as the invention itself, may be more fully understood from the following detailed description of the drawings in which:

FIG. 1 illustrates an architecture of a software system operating in accordance with the present invention;

FIG. 2 is a diagram illustrating the working of the persistence layer interacting with domain objects and a data store;

FIG. 3 is a diagram illustrating the interaction of business and domain objects;

FIG. 3A-1 is a diagram illustrating the interaction of views and domain objects;

FIG. 3A-2 is a diagram further illustrating the interaction of views and domain objects;

FIG. 3A-3 is a diagram illustrating parent-child views;

FIG. 3B is a diagram illustrating a view and its display in a GUI;

FIG. 4 is a diagram illustrating the relation between domain objects and the tables they are mapped to in a data store;

FIG. 5 is a diagram illustrating a controller's state machine;

FIG. 5A is a diagram illustrating the interaction of the controller with business and domain objects; and

FIG. 6 is a diagram illustrating an example of an adapter.

### DETAILED DESCRIPTION

Definition of Terms

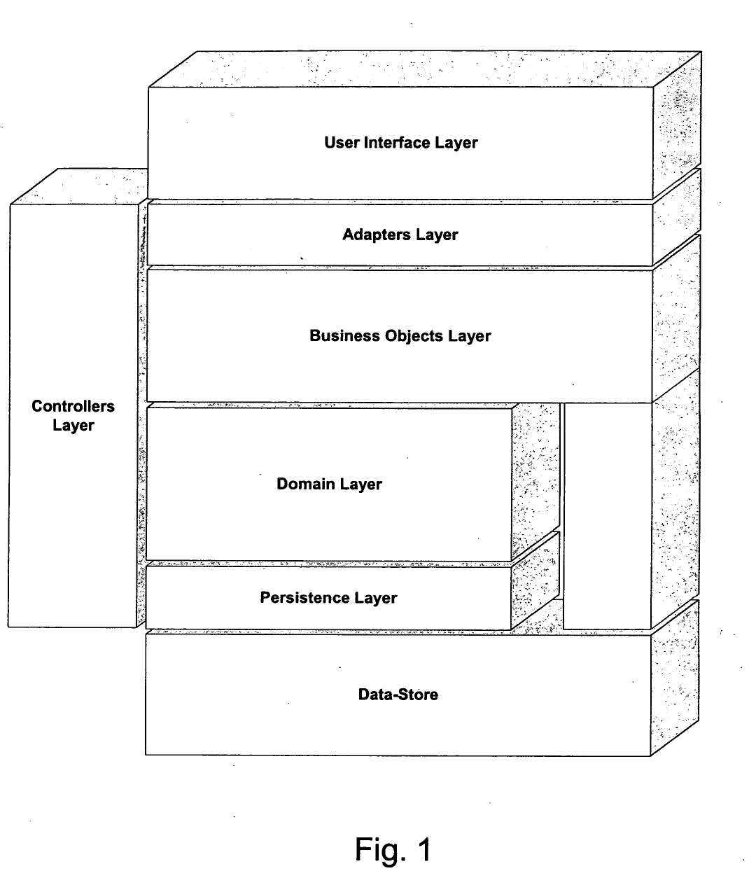

Before proceeding with a discussion of FIGS. 1-6, certain terminology is explained. As those familiar with the art will know, two separate and distinct computer-programming paradigms have been established for software development: the “procedural” paradigm and the “object-oriented” paradigm. The prior art has been divided along these lines, with a system being classified as either procedural or object-oriented. The preferred embodiment of the present invention is primarily implemented using object-oriented computer programming techniques (though certain procedural techniques are used for the controller layer). Object-oriented computer programming techniques involve the definition, generation, use, and destruction of software entities referred to as “objects.” Each object is an independent software entity comprised of data generally referred to as “attributes” and software routines generally referred to as “member functions” or “methods” which manipulate the data. The allocation of storage to hold an object's data is also sometimes referred to as “creation” or “instantiation” of an object.

One characteristic of an object is that only methods of that object can change the data contained in the object. The term “encapsulation” describes the concept of packaging the data and methods together in an object. Objects are thus said to encapsulate or hide the data and methods included as part of the object. The term encapsulation describes the concept that an object's data is protected from arbitrary and unintended use by other objects and thereby preventing corruption of an object's data.

To write an object-oriented computer program, a computer programmer conceives and writes computer code that defines a set of “object classes” or more simply “classes.” Each of these classes serves as a template that defines a data structure for holding the attributes and program instructions that perform the method of an object. Each class also includes an arrangement configured to instantiate or create an object from the class template. The arrangement configured to create an object is a method referred to as a “constructor.” Similarly, each class also includes an arrangement configured to destroy an object once it has been instantiated. The destroying arrangement is a method referred to as a “destructor.” In certain object-oriented languages, destruction may be implicitly defined.

When a processor of a computer executes an object-oriented computer program, the processor generates objects from the class information using the constructor methods. During program execution, one object is constructed, which may then construct other objects that may, in turn, construct other objects. Thus, a collection of objects that is constructed from one or more classes form the executing computer program.

Inheritance refers to a characteristic of object oriented programming techniques which allows software developers to re-use pre-existing computer code for classes. The inheritance characteristic allows software developers to avoid writing computer code from scratch. Rather, through inheritance, software developers can derive so-called subclasses from a base class. The subclasses inherit behaviors from base classes. The software developer can then customize the data attributes and methods of the subclasses to meet particular needs. For example, in our system and in other object-oriented business information systems, inheritance allows generic business classes to be customized for a specific business.

With a base-class/sub-class relationship, a first method having a particular name may be implemented in the base-class and a second different method with the same name may be implemented differently in the sub-class. When the program is executing, the first or second method may be called by a statement having a parameter that represents an object. The particular method that is called depends upon whether the object was created from the class or the sub-class. This concept is referred to as polymorphism.

For example, assume a computer program includes a class called Employee. Further assume that class Employee includes a member function that defines a series of method steps to be carried out when a worker retires from the company. In an object-oriented implementation, the retire method is automatically inherited by sub-classes of class Employee. Thus, if a class called Executive is a sub-class of the class called Employee, then class Executive automatically inherits the retire method which is a member function of the class Employee.

A company or organization, however, may have different methods for retiring an employee who is an executive and an employee who is not an executive. In this case, the sub-class Executive could include its own retire method which is performed when retiring an employee who is an executive. In this situation, the method for retiring executive employees contained in the Executive class overrides the method for retiring employees in general contained in the Employee class. With this base class/sub-class arrangement another object may include a method that invokes a retirement method. The actual retirement method that is invoked depends upon the object type used in the latter call. If an Executive object type is used in the call, the overriding retirement method is used. Otherwise, the retirement method in the base-class is used. The example is polymorphic because the retire operation has a different method of implementation depending upon whether the object used in the call is created from the Employee class or the Executive class and this is not determined until the program runs.

Since the implementation and manner in which data attributes and member functions within an object are hidden, a method call can be made without knowing which particular method should be invoked. Polymorphism thus extends the concept of encapsulation.

An abstract object class refers to any incomplete class that cannot therefore be used to instantiate semantically meaningful objects. An abstract class is used as a base class to provide common features, provide a minimum protocol for polymorphic substitution or declare missing common features that its derived class must supply prior to instantiation of an object.

Another way that polymorphism can arise in object-oriented software is through the use of interfaces. An interface is a set of operations that an object supports. This means that any software instructions that use any of the operations in the interface are valid. When a series of software instructions assumes some interface for an object with which it interacts, any instance may be substituted for that object, as long as the instance's class satisfies the interface.

Object-oriented computer programming techniques allow computer programs to be constructed of objects that have a specified behavior. Several different objects can be combined in a particular manner to construct a computer program that performs a particular function or provides a particular result. Each of the objects can be built out of other objects that, in turn, can be built out of other objects. This resembles complex machinery being built out of assemblies, subassemblies and so on.

For example, a circuit designer would not design and fabricate a video-cassette recorder (VCR) transistor by transistor. Rather, the circuit designer would use circuit components such as amplifiers, active filters and the like, each of which may contain hundreds or thousands of transistors. Each circuit component can be analogized to an object that performs a specific operation. Each circuit component has specific structural and functional characteristics and communicates with other circuit components in a particular manner. The circuit designer uses a bill of materials that lists each of the different types of circuit components that must be assembled to provide the VCR. Similarly, computer programs can be assembled from different types of objects each having specific structural and functional characteristics.

The term “client object,” or more simply “client,” refers to any object that uses the services of another object, which is typically referred to as the “server object” or “server.” The term “framework” can refer to a collection of inter-related classes that can provide a set of services (e.g., services for network communication) for a particular type of application program. Alternatively, a framework can refer to a set of interrelated classes that provide a set of services for a wide variety of application programs (e.g., foundation class libraries for providing a graphical user interface for a Windows system). A framework thus provides a plurality of individual classes and mechanisms that clients can use or adapt. Frameworks may make use of both inheritance and interfaces. A framework may supply a set of base classes that dictate some overall pattern of interaction between objects, with the expectation that framework users will design classes derived from the base classes to implement specific details of the functionality. Alternatively, a framework may specify a series of interfaces that designed classes should satisfy in order to interact properly. Finally, a framework can specify a set of patterns of interaction, which may be customized when designing classes using the framework. The customization would involve choosing which patterns should apply to a given class, choosing options for each pattern including the names of the components used and details of their use.

In the present invention, there are multiple levels of frameworks:

1. The basic classes of objects that are used in application design are constrained to domain objects, business objects, controller objects, and adapter/GUI components. All applications are constructed from specific classes of these generic objects.

2. A model of the core reusable business concepts for a particular business is captured in the domain model for that business. This domain provides a framework on which multiple business applications can be built.

3. For any particular application, the business objects selected from the domain for that application capture a framework for the processing required with the UI's and the controller for that particular application.

The Architecture

Referring now to FIG. 1, a diagram of an illustrative architecture 10 of the present invention includes a data store 12 which may for example be provided as relational database and a plurality of information layers 11. The data store 12 interfaces with a persistence layer. The persistence layer also interfaces with a domain layer 14. The domain layer also interfaces with a business-object layer 16, which includes one or more business objects. The business objects, in turn, interface with an adapter layer 18 that manages the user interface and a controller layer 22 that manages the flow of control in the application. (Though not depicted if FIG. 1, some business objects interact directly with the data-store layer instead of the domain layer, but this interaction is read-only, which preserves the domain layer's role as a point of integration.) As long as the adapter layer supports the programming language and can technically integrate into the development and run-time environment, the user interface can be written in any one of the range of software techniques while using the business objects for the supply of data and the manipulation of that data in response to user or application source code decisions.

Although the data store is often provided as a relational database, the domain may also represent data having an external data stream (e.g., EDI, XML) or some record-based interface (e.g., information shipped by character buffer or as an interface to legacy or third-party packaged software) as its source. These various data sources may be read/only or read/write, and may be used singly or in combination. From this point forward, we will use the term data store to represent any of these possibilities.

Assuming the data store is populated, and the business and domain objects have been instantiated, in operation a user manipulates the user interface 20 to perform a task. The user may, for example, simply want to retrieve certain data from the data store 12 or the user may want to perform a certain function that makes use of or modifies data from the data store and/or creates new data to be stored in the data store. Generally, the user will either retrieve or manipulate information in the data store 12 in some manner useful to the user.

In response to the user input received through the user interface, the adapters communicate with one or more business objects in the business-object layer 16 and/or with one or more controllers in the controller layer 22. An example might be an event-handling mechanism, which calls methods of application logic objects whenever some event is raised (e.g., in response to the click of a button). The adapters provide the association between the events raised and the business object and/or controller methods to be called in response to the user activity. There is typically some representation of data expected by the user interface, such as a specific way to provide tabular data, or a specific way to indicate what possible values to display in a drop-down list for an entry field. The user interface layer invokes methods of the adapters to obtain required information from business objects and/or controllers, and presents it in the correct way expected by the user. The adapters also invoke methods on user interface features in response to requests from the business objects and controllers.

Note that it is possible to locate the data store on a platform that is different from the platform hosting the business and domain objects without adversely effecting the operation of the system, since the frequency of interaction between the data store and the business and domain objects is reduced and ideally is minimized. That is, business objects primarily interact with domain objects rather than the data store and the interaction between the domain objects and the data store is intended to be as infrequent as possible. For example, ideally domain objects retrieve each piece of data needed from the data store only once (e.g., upon initial building of the domain objects) and access the data store one additional time to persist data to the data store prior to their destruction.

Furthermore, in a preferred embodiment, the business objects and domain objects are resident on the same machine to thus increase the speed and processing benefits gained by having business objects interact with domain objects rather than with a data store or other storage device which may typically exist on a machine or processing device different from the machine on which the business objects reside. This is particularly true in large software systems that involve complex business object models with complex inheritance hierarchies and large numbers of object relationships characteristics and that also include multi-user data stores that can be both relational and non-relational.

It should be noted, however, that although it is preferred for the business and domain objects to operate on the same platform, operation of the business and domain objects on different platforms is within the scope of the present invention. The final decision can be left for deployment and run-time and may involve scalability, security and software licensing concerns.

The Domain Layer

Referring again to FIG. 1, the core of every application built according to the architecture 10 is formed by the domain object layer 14. Conceptually, the domain layer is used to model the business a company is involved in. It describes the components the business is built from as well as their interrelations. It defines and implements the business logic and the business rules. At run time, the domain layer will also perform some of the functions of a data cache, but as will be described in detail below, it performs many other functions as well. The domain layer may thus be thought of as a “conceptual cache.”

The structure of the domain layer typically parallels the design of the tables for a relational database, but the object-oriented specification language provides for a far more flexible data structure than the flat relational structure. One important step to building a system for a company is to identify and provide domain objects having appropriate data structures and member functions. When properly designed the domain layer will be reused, acting as the foundation on which all applications for that company are built, and providing the location where updates in the actual business logic should be reflected in the applications.

Data stored in domain objects corresponds to data utilized by business objects in the business-object layer 16 in accomplishing functions for a user. In this scheme, the domain layer provides the point of integration because all operations intended to affect the data store are made together in the domain cache during the course of the application. The domain cache thus provides a “staging area” for changes to data. All business objects used in the same application can be coordinated via developer code to contain data 100% consistent with each other and with the domain cache whenever desired. In contrast to a possible redundancy in the data stored in various business objects, data stored in the domain cache is unique to the object it is contained in.

Data caching is a well-known technique in the art of business-application development. It is generally intended to improve performance for applications that need to extract information from a persistent data store, such as a relational database. In relational-database management systems, caching of information in memory alleviates the need for multiple, relatively slow disk read operations. For business applications, adding a cache component alleviates the need for multiple database and costly network transactions from within the application. It furthermore allows one to separate the tasks of extracting the data from the persistent store, from manipulating the information by other logical components (such as the business-object layer 16) in the application. In some systems for building business objects from database information, developers need to know nothing about this cache, and the data cache is not referenced by any of their code. In our scheme, domain objects are considered first-class objects, treated at the same level as the other components in the application. We term this domain cache a “conceptual cache” because the objects added to the cache during the execution of an application are determined and organized based on the business concepts managed by the application.

In this way domain objects serve as an interface between business objects in the business-object layer 16 and a data store 12 and thus interact with both the business objects and the data store. Since business objects can receive data from domain objects, rather than from the data store, domain objects eliminate the need for business objects to map data to the data store as business objects are created and/or destroyed. The life cycle is such that objects in the domain layer exist for a relatively long period of time, allowing new business objects to reuse the information stored within them without requiring new data-store access.

In the present invention, domain objects in the domain layer 14 have stored therein data retrieved from the data store 12 via a data-store access. Domain objects thus contain a duplicate of at least a subset of the information in the data store together with some new or changed information different from the information stored in the data store. During the course of an execution of an application, required information will be queried from the data store and domain objects mirroring this information will be constructed. During the course of the execution, additional domain objects representing new information will be constructed, and some domain objects will be modified to be different from the information in the data store from which they were constructed. Some domain objects constructed from the data store will be marked for deletion. Thus the domain-object cache may become “dirty” with respect to the data-store representation of information as the application execution proceeds.

When it is desired to coordinate with the data store, the domain cache is made consistent with data-store information once again via the persistence layer. Since business objects have already been maintained consistently with respect to the domain cache, all of the application's business object information can be made consistent with the data store together. It still remains to coordinate between different applications carefully to avoid conflicts between the different interactions of the various application executions with the data store. This coordination is outside the scope of the present invention. However, the complexity of the problem is greatly reduced by eliminating the problem of coordinating within each single application.

A further benefit of this scheme is that business objects can avoid many data store interactions during an execution under certain circumstances. It is a common occurrence in applications that several instances of a particular business object are used within the same application. An example would be that of a business object for handling customer information. There may be several customers whose information will be handled within the same execution of the application. It is common that a business object be constructed for customer A and used during some segment of time. Typically, when the segment of time ends, the data for customer A is returned to the data store. Subsequently the data for another customer B may be used to construct another business object, and that business object processed for a period of time. Subsequent to that, if it is desired to process the information for customer A again, that information must be extracted from the data store once again. In this scheme, if the system developer knows or checks that the information in the data store has not changed since it was originally used to construct the domain objects in the cache, the business object for customer A can be built directly from domain layer data without any other data-store interaction.

In the present invention, all change of representation is made in the creation of the objects in the domain cache. This means that the domain cache remains the only logical source of data for the business objects, whose design and coding is therefore simplified by the uniformity and regularity of the structure of the domain, and the availability of the design language (and its OQL subset) to traverse that structure. The domain buffers the application designer against having to know details about the physical data stores. Thus, many different types of data stores may be used with the present invention. These include legacy databases (including non-relational databases), data services coded by other developers that hide some data sources and instead respond only to native language messages as queries, data feeds, electronic data interchange, or even flat files. In each of these cases, querying the information is integrated into the access class design, so as to use each data source for the instantiation of domain objects. Once the domain cache has been augmented with the objects resulting from these sources, business objects can work with the domain data without regard to its origin. Once built, domain objects can be subsequently persisted to the data store representing the ongoing persistent store for domain information. That information can also be rebuilt directly from the persistent store in subsequent logical units of work.

Aside from providing common storage for the values business objects manipulate, the domain provides a wide range of additional services to business objects having to do with common ways business objects need to work with the common information. Examples include:

1. Information about default and enumerated possible values associated with attributes, where relevant, for display in choice sets such as list boxes and combo boxes in a visual interface, or for pre-filling values when fields are initialized.

2. An undo/redo mechanism that allows common business object state to be rolled back to points in time specified by application code, similar to a database transaction mechanism but applicable only to the objects cached in the domain. This mechanism allows incorrect entries to be backed out when error conditions apply, or for users to change their minds in “what-if” analyses. The use of this mechanism is managed in the controller layer.

3. Support for automatic refreshing of business object information when it becomes “dirty” with respect to the domain cache. It is common for several different business objects to display different versions of identical data. Typically, it is required that when the information is updated in one place (e.g., a specific input field in a graphical user interface), other places that display the information (e.g., a read only header on another window) be updated at the same time. When developers choose this option, business objects are efficiently and automatically refreshed via signals raised in the domain.

As mentioned above, apart from providing a cache-like middle layer between business objects and the data store, domain objects perform a variety of other functions. In general these are related to the interpretation of the domain as a conceptual cache, modeling the business logic aspects of a company, as opposed to the application logic stored in the business-object layer. Examples are validation of information in the data store (i.e., ensuring that information stored in and retrieved from the data store is valid in the sense that the information is accurate and complete), performing computations to calculate derived information, and packaging of “low level” data manipulation.

To guarantee that information stored to and retrieved from the data store is valid, a domain object may use a set of rules at the attribute level (e.g., the value of this attribute must be “red,” “green,” or “blue”) or at a higher level (e.g., each customer must have at least one home address). Individual rules are implemented as methods of domain classes. There are three varieties of domain data rules. In the first, a standard property of an individual attribute is tested and compared to a desired result. Examples include testing that a string has no more than a specified number of characters, that a string has no blank spaces, or that an integer is no more than a certain maximum amount or less than a specified minimum amount. In the second variety of rule, a more complex requirement can be tested of an individual attribute. This kind of rule might specify that, given other existing values in domain data, the particular attribute cannot be set to a certain value. This second kind of rule maintains required relationships at the attribute level. Both the first and second kind of rule can be applied before allowing an attribute to be set in the domain. This allows a user to be informed that entered information would not be correct without actually changing the domain objects to hold data invalid with respect to these rules. A third kind of rule tests arbitrary properties of domain data against expected values for those properties. An example of this kind of rule would be a test that if an insurance policy has a number of coverages, that the effective period for each of the coverages should lie within the effective period for the policy. This kind of rule is often impractical to apply every time the user seeks to change a single attribute within the domain. For example, it is impossible to change the effective periods of a policy and all of its coverages to one year later one date at a time without this rule begin violated until all dates have been changed. It is more practical to wait until all dates have been changed, and to apply the test at that time. To handle this situation, rules of this third kind are not automatically applied, but instead applied when specified in software by the developer. Additionally, all rules are always applied before any domain data is reapplied to the data store via the persistence layer. This ensures that data-store information is always valid with respect to domain object rules.

A related feature enabled via the use of the domain cache is integrated messaging which provides a mechanism for giving notice to other users that errors occurred. The messaging system is in the domain layer and since the domain layer relies on integrated information the fact that the integrated messaging is in the domain layer makes the integrated messaging easier to implement. When specified by developers, business objects write their updated values back to the domain-object attributes from which the values were originally queried. At that time, the business object logic can apply any of the domain rules. When a rule is violated, a selected error, warning, or informational message may be posted to a common message queue. The posting instance can give additional information about the message, such as which instance posted it and the attributes used to determine that the rule was violated. The messaging system integrates with the adapters to provide the user with information about the fields in the UI that were related to the data problems that resulted in the posting of the message.

The calculation of derived information is to present information that depends on other information and can be calculated if all the values on which it depends are known. A simple example might involve an object that has date information, say, the date of delivery. Derived information might include the day of the week the delivery is to be made, which can be computed once the date of delivery is set. A domain object can provide an arrangement configured to request the day of the week of delivery. There are two possible ways to calculate derived information. In the first way, the value is never stored in any variables, but instead is recalculated every time it is needed. In the second way, the value is stored in a variable, but the variable is recalculated whenever one of the values on which it depends is modified.

The packaging of low-level data manipulation allows information that exists in multiple places to be changed at one time (e.g., the creation/deletion of several things at one time). For example, objects of a class A may be associated with objects of a class B, and each object of class A may only be valid if its data has values in conformance with the data in the associated instance of B, according to some rule. For example, a date in the instance of A may need to come strictly after a date represented in the associated instance of B. Instead of requiring business objects to separately set the dates in the two objects, we may choose to provide an update method on the class A that simultaneously modifies the dates in both objects so as to guarantee conformance with the rules.

The Persistence Layer

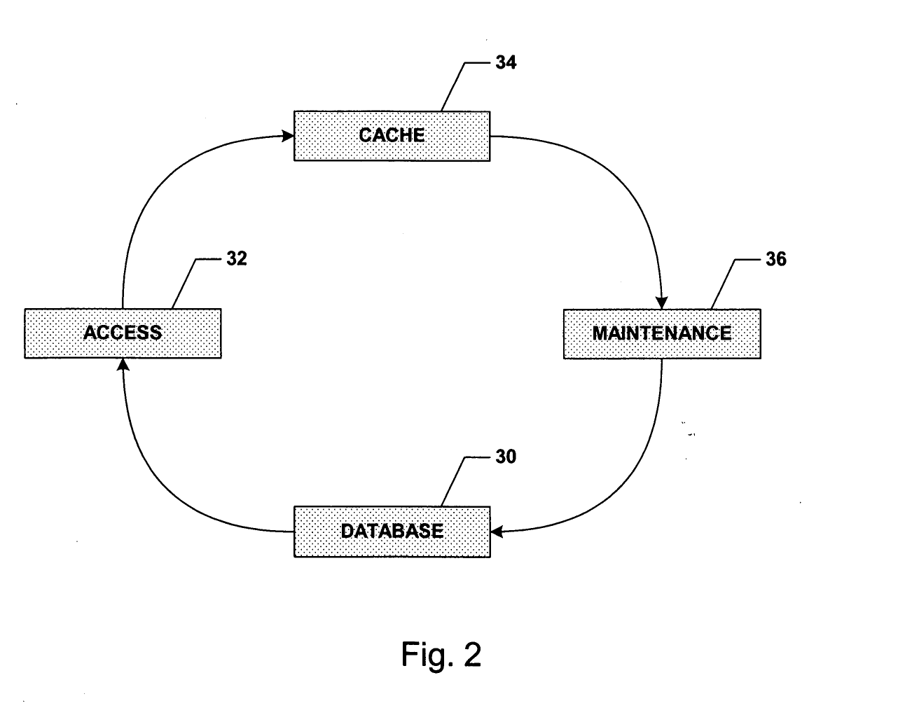

Referring now to FIG. 2, a diagram illustrating the functions performed between the cache provided by the domain objects and the data store is shown. Four conceptual entities are depicted in FIG. 2: the domain cache, the data store, and the access and mapping halves of the persistence layer. Individual domain classes/objects contain no code for managing their storage and retrieval in the data store. Instead, access classes extract domain objects from the data store and mapping classes store them in the data store.

As indicated in block 32, the domain cache accesses a data store 30 to retrieve information to build the domain objects it contains. A domain object stores retrieved data for future use by business objects. A business object can access the data via the domain object (rather than by performing a data store access directly) and thus the domain object acts as a cache 34. The data is maintained as shown in block 36 and eventually returned to the data store 30 where the information can again be accessed by a domain object as shown in block 32.

The separation of persistence from the domain itself allows for switching data stores, communication methods and middleware and even data representation formats without affecting the domain objects themselves.

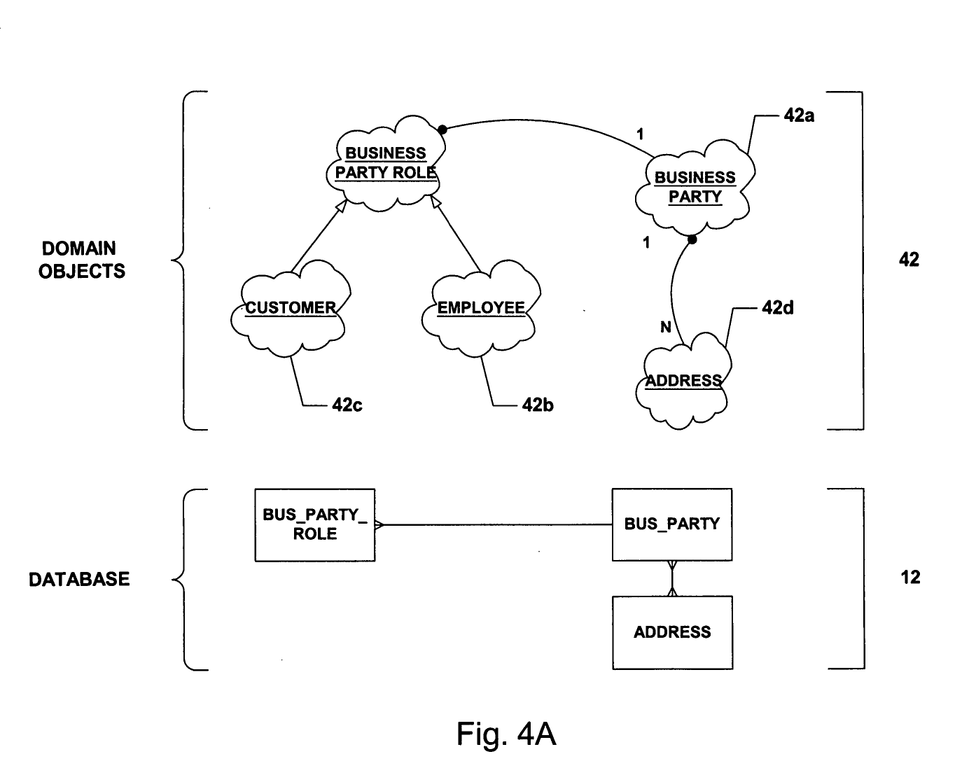

Referring now to FIG. 4, a plurality of domain objects 42a-42d generally denoted 42 and a data store 12 are shown. In the preferred embodiment, domain classes may be mapped to any relational database table structure, or any record-based native interface. Mapping involves associating the class with one or more tables, and each attribute or property may be associated with columns of those tables. In the preferred embodiment, the design language allows for the mapping of domain classes, and compiles this information to SQL for updating the tables with domain information and the native code to wrap the SQL so that the maintenance classes work within the native environment. The design syntax also allows for the description of access classes. Both relational databases and services that return collections of flat records are often significantly more efficient when they are allowed to return complex joins of information and larger result sets. Although access defaults are produced automatically so that no queries need be written for the domain cache to be filled with new domain information, additional designer-defined access classes can also be created, and associated with a specific domain cache. If done this way, the more efficiently coded data-store queries can be used to fill the domain class more efficiently.

There are two ways that the domain cache may fetch additional domain object information. The first, or passive mode, applies whenever a sought-for domain object does not already exist in the cache. At that time, an associated access class is automatically used to bring that object into memory by querying the data store and building the object. By developer choice, other related objects may be brought into the conceptual cache at the same time, applying locality-of-reference considerations and using the power of relational databases and other data stores to supply a small number of large data sets more efficiently than a large number of small data sets. The policy of which objects to bring together may be left to the default supplied by the cache, or explicitly chosen through the optimization criteria of the developer.

A second, or active mode, involves pre-fetching domain objects to expedite the processing of certain information. In this case, a controller can explicitly initiate the database access by direct request to the domain cache. For example, the domain cache may be instructed to pre-fetch from the data store certain information known to have a relatively long retrieval time if a controller anticipates an upcoming need for the information.

In both cases we may take advantage of the greater speed and flexibility afforded by “joins”, or selections of large amounts of data at one time, from which multiple objects can be built in the domain in one logical step. Both the passive and active modes of access allow developers to tune their queries and the objects built from them to take advantage of available database optimizations.

The mapping half of the persistence layer has two primary responsibilities. First, it contains the attribute-to-column or attribute-to-record field mapping showing how primitive data values are to be moved from one location to another. Second, it shows how the representation for that data might change as it moves. This includes change of data type as well as value by value mapping, if applicable to a particular attribute. Note that as opposed to access, mapping inherently operates a single object at a time, since all data stores process changes in this fashion.

The Business-Object Layer

The business-object layer is the part of the application that deals specifically with the display and manipulation of the domain layer, and it acts as an interface between the domain layer and the user interface (UI) through the adapter layer.

This section is organized as follows:

1. Definitions and terms

2. Requirements

3. Specification

4. Compilation

5. Usage

Definitions and Terms

In the following description of the business-object layer, we will use the terms that are, for the most part, consistent with the terms used in the art. There are four basic categories of types recognizable in our implementation of OQL (heretofore referred to as “basic types”): “primitive types” (integer, string, etc), “reference types” (the classes associated with the domain layer), “collection types” (bags, sets and ordered collections), and “structure types” (business-object classes are examples of structure types). It should be noted that collection types and structure types are compound types in that a collection type, in addition to specifying bag, set, or ordered collection, also specifies an element type, which can be any of the four basic types, and a structure type specifies the type of each of its attributes in a similar fashion.

A “view” class is a class responsible for computing some property of the domain layer. In most cases, a view class is a class used to instantiate business objects. A “business object” class is a structure type with additional methods. In particular, a business-object class will have methods for getting and setting attributes by name.

The primary purpose of a business object is to provide information to a user and/or to perform one or more functions manipulating that information as desired by a user via the UI. Business objects are selected to present to the user information that the user wants to access to accomplish a specific data-related task. The business-object layer thus drives the user interface. Accordingly, the specification of a business object may be motivated by the particular needs of the UI.

Requirements of Business Objects

Generally, business objects function to manipulate data (e.g., in accordance with some business rules) to determine what combination of data to present to and/or capture from the user and to determine workflow. Business objects can also be used to hold processing data structures and to code atomic manipulations of those data structures via business object methods. For example, business objects can be used for algorithms in batch applications with no user interface at all. In such uses, the application information can be arranged in data structures that enable connections between application information to be represented that make processing instructions more efficient to encode and easier to decompose.

Business objects are instantiated by views, which extract information from domain objects by querying the domain layer. This activity consists of accepting zero or more parameters that may include references to domain objects or primitive values (such as strings or integers). Source code can be written to traverse cached domain objects, following references from one domain object to another and extracting values to be presented in the business objects. In a preferred embodiment, such extraction of information is accomplished using Object Query Language (OQL). Business objects include primitives that allow them to manipulate data in a desired manner. This manipulation may include creating new business objects without extracting values from the domain, setting attributes of these new objects to some default values, assigning the value of a given attribute to be contingent on the values of other business object attributes or on properties of related business objects (similar to spreadsheet-like functionality) or presenting a pre-defined list of values from which a given attribute's value must be chosen. When instructed to by code in the adapter and/or controller layers, business objects will interact with their associated domain objects to update manipulated data. Business objects are provided with the functionality and logic to drive a user interface (via adapters) that may, for example, be provided as a graphical user interface (GUI). For example, business objects may include data and functions that fill in values in pull down menus, enable buttons, etc. It should be noted, however, that such functionality in business objects is accomplished in an abstract manner. The business objects need not include the information necessary to the operation of a specific user interface. Instead, they need only represent the information in a form understandable to the adapter layer.

It should be noted that in prior art systems business objects are built from a data store such as a relational database. SQL, the standard query language for extracting subsets of data from a relational database, is used to construct business objects. The business objects are described in the implementation language (such as Java or C++). These business objects determine how information is presented to other application software and how that software may work with the data, and they encapsulate the rules governing the validity of data. When business objects are persisted, update statements in SQL (INSERT, UPDATE and DELETE) are used to make the data changes known to the relational database. This means that business objects are two layers of abstraction above the data store, and the code that implements the business objects must span both layers of abstraction. Specifically, business objects must associate contextual meaning with values stored in database rows, and must also extract the subset of information from this context-based information needed to solve the process problem at hand.

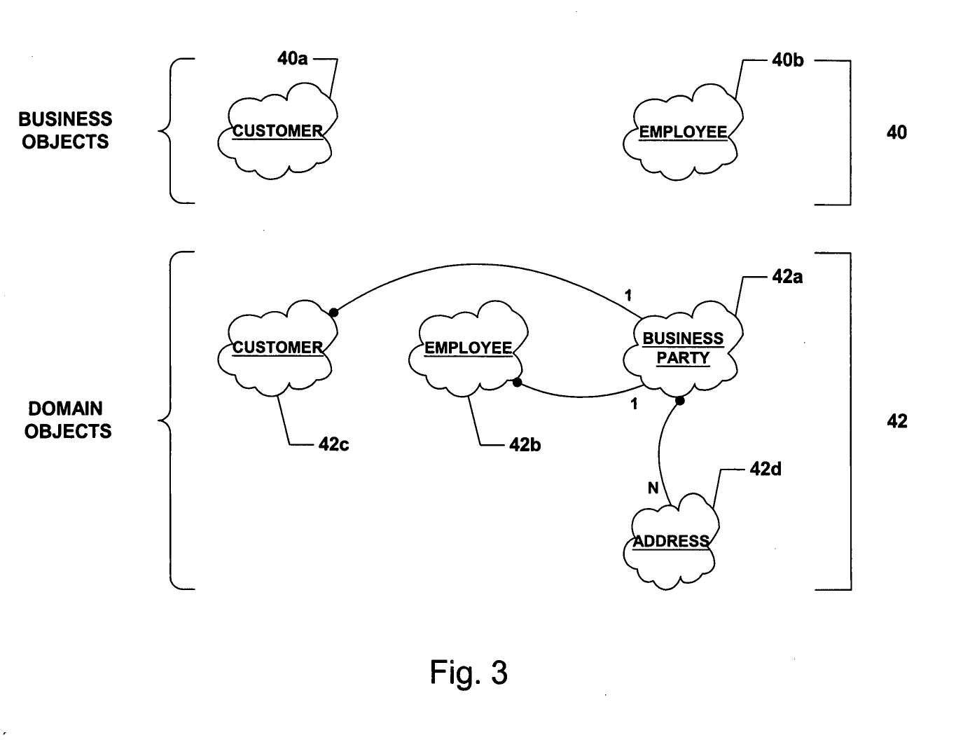

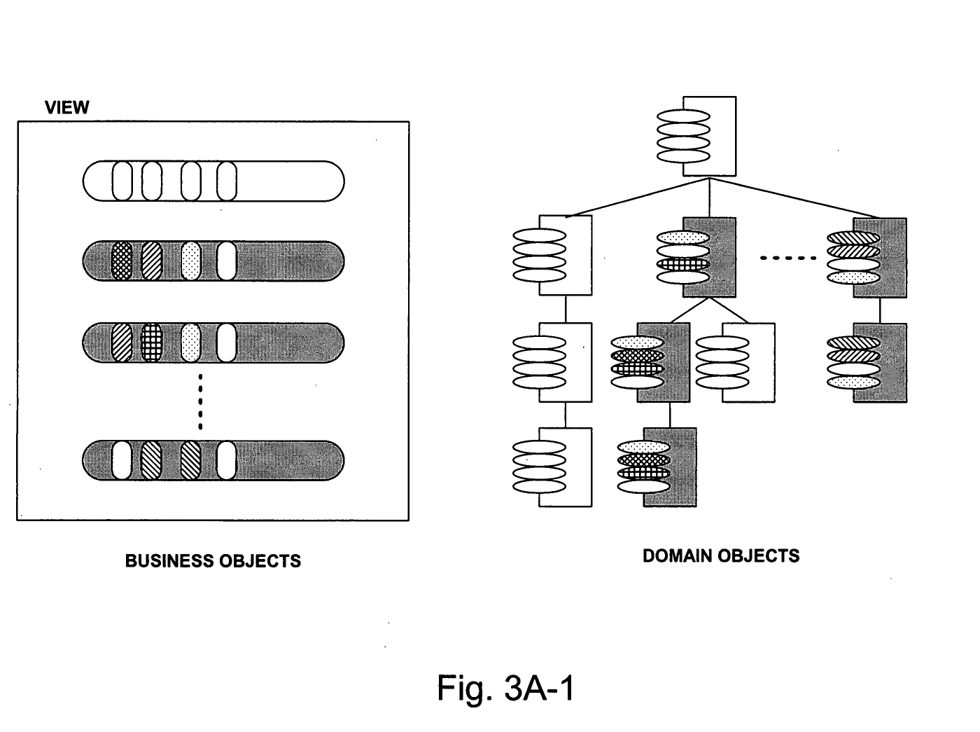

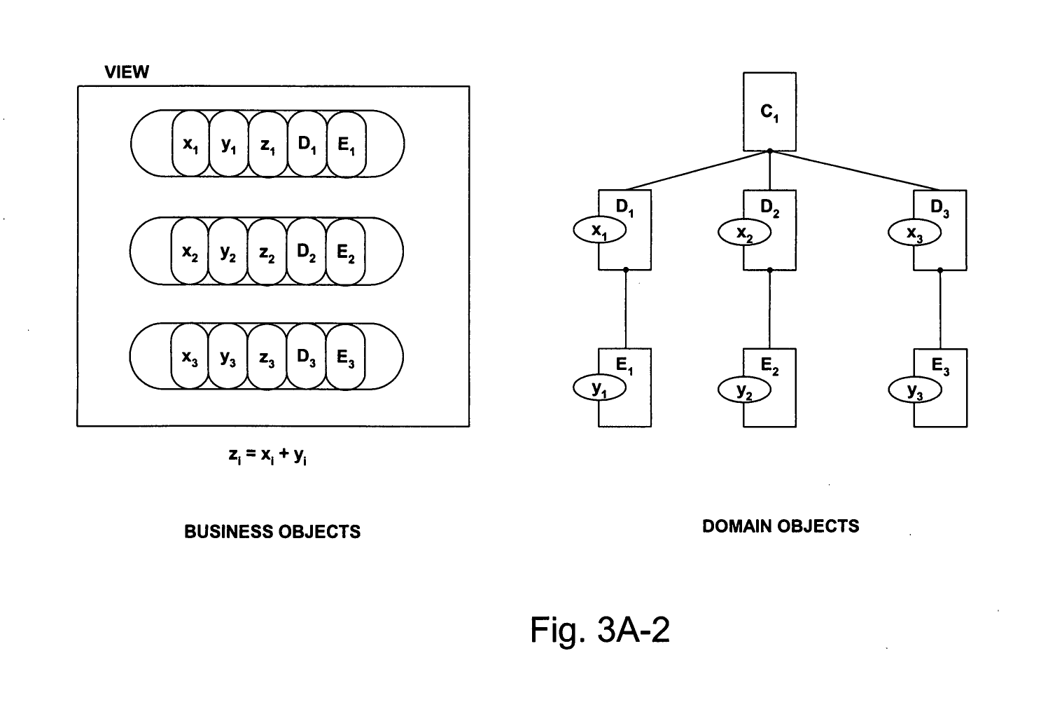

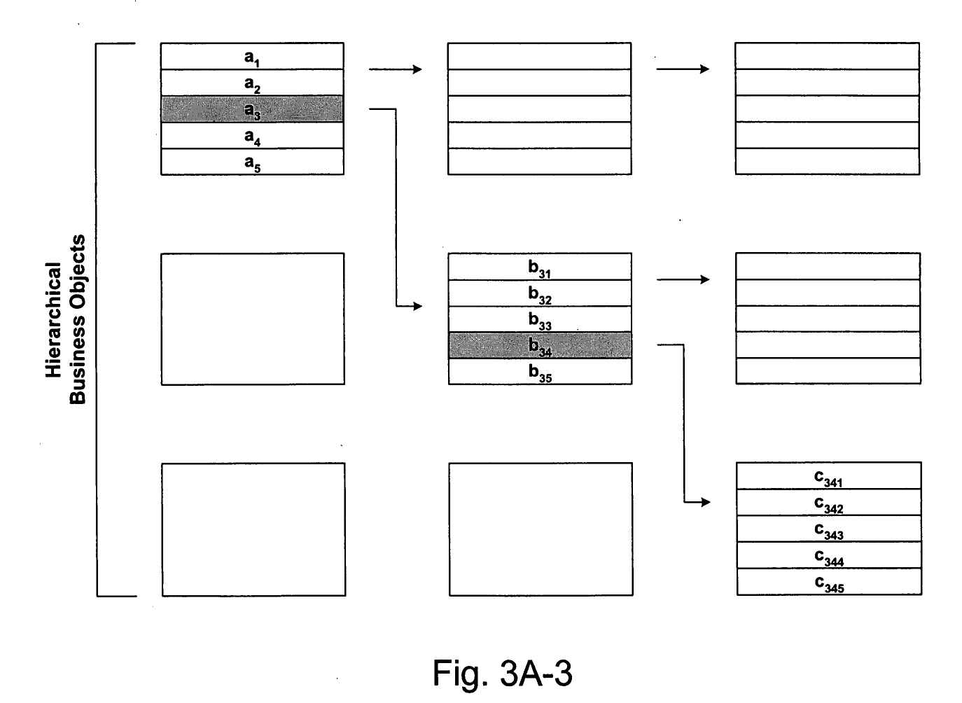

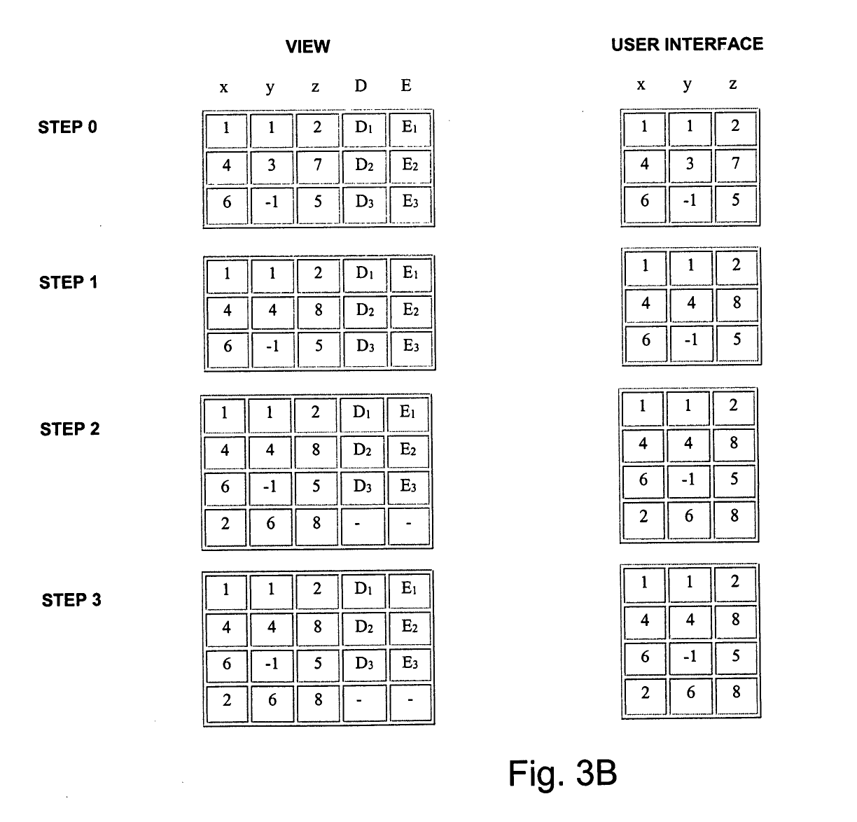

One example of these two layers can be found in the building of a business object to manipulate the details of customer information (see FIG. 3). The customer's address may be represented by several address objects, one of which may hold a telephone number, another of which may hold a street address, and a third of which may hold an e-mail account name. We may choose to store all of these different types of address in a single address table, but the specific operations available to work with each of these types of address need to be associated with the data when it is extracted from the database and brought into memory to be processed. This is one level of abstraction, and it remains unchanged between different applications that work with address information. Additionally, the customer business object may have certain subsets of the address information in which it is interested, and certain additional rules for working with addresses that also need to be coded into the business object. This second layer of abstraction may be different for working with customers than with employees, and thus changes much more frequently between applications.

One of the main efficiencies in design and implementation work comes from the explicit separation of these two levels of abstraction and the resulting reduction in re-work and design complexity of software.

The second benefit of this explicit separation is that two business objects involved in the same application often extract subsets of information from the same instances of context-based information. In the previous example, this might mean that some common address information is displayed and manipulated in two different locations in a user interface or application process structures. Having an intermediate representation between a data store and business objects affords a point of coordination between the business objects.

The third benefit (described in detail above and not further elaborated here) is the efficient cache afforded by this intermediate representation, which can be exploited to reduce data store loads and minimize communication latency.

Specification of business objects

In accordance with the present invention, OQL is used in two ways:

1. to infer class definitions for views and business objects, and

2. to define methods for querying information from domain objects in order to instantiate and initialize business objects, and to associate attributes of these business objects with the domain-object attributes from which their values were obtained.

We will describe in some detail how OQL (along with the enhancements added to OQL that are part of this invention) is used to specify the business-object layer. In order to define a business-object class, the designer needs to define the view class that will create instances of the class. Business objects defined using the invented specification language have “intrinsic knowledge” of their domain-object sources and, therefore, they have built-in default behavior for storing information back to the domain layer.

Suppose we would like to define a business object to describe for the UI a street address. We define a view class “streetaddress” using the specification language as follows:

| | |
|---|---|
| 1 | define streetAddress(StreetAddress addr) |
| 2 | with key (addr) |
| 3 | child countries( ) |
| 4 | displaying name at countryName |
| 5 | updating country with country |
| 6 | child states(country) |
| 7 | displaying abbrev at abbreviation |
| 8 | updating state with state |
| 9 | as |
| 10 | select addr, |
| 11 | addr.streetAddress1, |
| 12 | addr.streetAddress2, |
| 13 | addr.city, |
| 14 | addr.stateReference as state, |
| 15 | state.abbreviation, |
| 16 | addr.countryReference as country, |
| 17 | country.name as countryName, |
| 18 | addr.postalCode |

There are a few noteworthy elements to the above definition. It is suggested in standard OQL that named queries can be defined using the “define” syntax above. The present innovation has adopted this syntax in its specification language. The “body” of the definition is defined to be the (almost pure) OQL that follows the “as” (on the line 9). It is “almost pure” in that any pure OQL would be adequate, but the present invention adds to the standard wherever it could to make the definition of business objects more natural. There are two such extensions in the above example. The first is that the “select” has no corresponding “from”. In the standard, a select-statement iterates over one or more collections declared in a from-clause and returns a collection of structures. In the present invention's implementation of OQL, if there is no from-clause, a select-statement returns a single structure. The second extension to standard OQL is the ability to define projection attributes that depend on previously defined attribute aliases (specifically, these dependent attributes' values are computed from the other attributes, both initially and whenever the other attributes' values change due to manipulation of the business object). For example, the projection attribute “country.name” would have had to written as “addr.countryReference.name” if it were to have been written in pure OQL.

The OQL techniques of the present invention allow packaging of results into business objects, specification of data manipulation within business objects using OQL, and signaling to a user interface (via the adapter layer). One example of data manipulation specification is describing how one attribute may depend on other attribute values (e.g., attribute a1 is always the sum of attributes a2 and a3, even as they are changed by user actions or programmatically). Another is the specification of the conditions under which modifications of an attribute are allowed and when the attribute is unchangeable. Examples of signaling to a user interface include changes in emphasis (which may be displayed visually by changing color, putting a value in parentheses or making a sound) or signaling when one GUI panel should be shown out of a set of choices of which panel to show in a given space in the GUI.

Business objects are managed by views, which are instances of classes that have sufficient knowledge of the domain and application variables to be able to properly manage business object lifecycle in the context of a particular instance of an application. Optionally, a view may have parameters that describe primitive information (e.g., identifiers or string properties) or are object references sufficient to supply the context in which the business object or objects will exist. A view may contain a single business object by definition, or it may contain a collection of business objects that may contain zero, one or more business objects depending on view parameters, the domain objects present in the domain cache and data store, and the state of the application.

Compilation of the Specification

When the above definition is compiled, two classes are generated: the view class and the business-object class. The body of the OQL defines the business-object class StreetAddressBusinessObject. This class is a structure type with attributes having the following names and types:

1. addr (StreetAddress)

2. streetaddress1 (string)

3. streetAddress2 (string)

4. city (string)

5. state (GeographicUnit)

6. abbreviation (string)

7. country (GeographicUnit)

8. countryName (string)

The “preamble” (everything before the “as” on line 9) describes extra features of both the business-object class and view class. In particular, the view class StreetAddressView will have a parameter (an instance variable on the class) called addr of type StreetAddress. The specification also indicates that the attribute addr of the business object is a key attribute (it can be used to uniquely identify a business object of type StreetAddressBusinessObject).

The business-object class will have specific methods for saving itself to the domain based on the StreetAddress source information. For instance, if in the UI a user were to modify the postal code of a street address, the save method of the business object would know to modify the postalCode attribute of the underlying StreetAddress object.

Using the Business-Object Layer

There are three distinct phases in a usage of a view. In the first phase, the view is initialized by performing a query, which is some combination of traversal of the domain cache, together with constant initial values or derived values computed from the constants and the data extracted from the domain. FIG. 3A-1 shows how a view would traverse domain objects to build one or more business objects. FIG. 3A-2 shows a specific example, in which three business objects of class B are built by traversing through instances of classes C, D and E. In the figure, a single instance C₁ of C exists, containing three instances of D, D₁ referencing instance E₁ of E, D₂ referencing instance E₂ of E, and D₃ referencing instance E₃ of E. The single parameter to the query Q is a reference to the instance C₁. For i=1, 2, 3, business object Bᵢ is built by extracting attribute xᵢ from Dᵢ and attribute yᵢ from Eᵢ. A third business object attribute zᵢ is created by adding xᵢ and yᵢ after they have been stored in the business object. Additionally, references to the traversed objects Dᵢ and Eᵢ are captured in instance variables of the business objects. These will be useful in the third phase when the business objects are synchronized with the domain once again.

In this invention, the Object Query Language has been enhanced to allow query result sets to be presented as business objects in views. For example, syntax has been added to specify keys for business objects created as a result of OQL. Keys are useful because the present invention provides a mechanism for designating one or more of a view's business objects as the view's “current result(s)”, and we often want to initialize a view by selecting a specific business object to be its current result; the key provides a unique identifier for this business object. (A view's current result is often indicated in a graphical user interface by highlighting the row corresponding to the selected business object in the table corresponding to the entire view.) There are also many times in which a view is re-initialized, and an entirely new set of business objects is created. To the user, the table showing the business objects should not appear any different even though the business objects are different. We must make sure the “same” row is selected for the user. To solve this problem, the view remembers the key of the business object selected before the view was refreshed, and initializes the view of new business objects by selecting the new business object with the same key as the user's previous selection. To the user, it will appear that the selected rows have not changed. In the street address example, line 2 specifies a key for the business object. If a view were to be defined which displayed a collection of such business objects, reselection would be based on the addr (StreetAddress) attribute.

It is also possible to define dependencies between business objects in the invented specification language. Not only can a business object be a parameter to another business object, also hierarchical relationships can exist between object views. For instance, we may want one business object to reference another business object or to contain a collection of other business objects. The specification language includes constructs outside the realm of the ODMG OQL standard that make it possible to specify dependency relationships between views in a conceptual way. An instance of one view can be declared as a “child” of another view (we will refer to the second view as the “parent” view). The parent view can then use the child view to update attributes of the parent's business objects, or to display further details for each of its business objects. For example, if the parent view contains business objects describing a customer (each business object may display the name and id of a customer), then an associated child may display a collection of addresses associated with the customer. Another example is depicted in FIG. 3A-3, which shows three tables depicting hierarchical business objects. When a row (associated with a business object) is selected in the first table, the second table is refreshed to show the business objects contained in the selected business object. When the user selects a row in this second table, the third table is similarly refreshed to show additional breakdown information. This behavior is specified using only the parent-child syntax.

A child view can also be used to fill the contents of a drop down for a business object. A business object presenting street-address information uses an example of this feature. In this example, the street address needs to show a country and state. When examining the country, the user should be presented with a list of country business objects, each corresponding to a reference object representing a distinct country. Similarly, when examining a state, the user should be presented with a list of the states for the selected country in another collection of business objects. Changing the selected country business object should change the state business objects as well. Furthermore, the business object corresponding to the country chosen for the street address should be pre-selected when the list is shown, and selecting a different country business object should update the country associated with the street address as well. (Similar behavior should hold for the state.) Lines 3 through 8 in the example OQL specification for the StreetAddressView and StreetAddressBusinessObject set up these precise relationships. The business object keys (in this case of the CountriesBusinessObject and the StatesBusinessObject) are used to (1) set parameters for and initialize contained collections of business objects, (2) ensure that containing object information is used to set the key of the selected business object in a contained collection, and (3) setting the information in the containing object when selections below change.

In the second phase, the view and business objects are used in whatever application control flow is indicated by user activity or algorithmic use of the business objects by application code. FIG. 3B shows four snapshots taken during this phase in our continuing example. The left side of the figure shows the state of the view at each point in time, and the right side shows how that view might appear in a graphical user interface if shown in table format (such as a JTable in Java). As in FIG. 3A-2, D₁, D₂, and D₃ are instances of the domain class D; E₁, E₂, and E₃ are instances of the domain class E; and for i=1, 2, 3, xᵢ and yᵢ are values of attributes on Dᵢ and Eᵢ, respectively, and zᵢ+yᵢ. If the three business objects are displayed in a graphical user interface, the user may change the value of the attribute x₂ from 3 to 4. This has the immediate effect of also updating the value of z₂ from 7 to 8 to maintain the invariant z₂=x₂+y₂. The user may next take some action that causes the application to indicate to the view that a new business object should be created as the last (fourth) business object. The new business object is created with default values for x₄, y₄ and z₄, and no references to the domain since there are no associated domain objects traversed to build this new business object. (Alternatively, we can build the new domain objects corresponding to this new business object at the same time the business object is instantiated.) The attributes of the new business object may be viewed and changed the same as the attributes of any other business object. The last user action may indicate to the application that the user chooses to delete the third business object from the view. This causes the application to have the view mark the business object as deleted, and the business object to not be shown in the graphical user interface.

In this invention, the OQL syntax has been significantly enhanced to provide a complete set of primitives to specify how updating of business object attributes may be governed, the ways in which business-object information can be displayed in a user interface, and associated information such as choice sets to be displayed in drop-downs, combo boxes and other displays to enable user input to business object attributes. Provision has also been made to code methods on the business objects constructed from the OQL, to package some of the functionality required during this second phase while business objects are used to perform application tasks.

In the third phase, application control code instructs the view to store changes to the domain, thereby synchronizing the domain with changes made in the second phase to the view's business objects. The last design decision that must be specified for a business object is the required changes that must be made to domain objects associated with the business object when it has been newly created, modified, or deleted. In each of these cases, there must be a description in native code syntax (e.g., Java) of the step-by-step modifications in the domain necessary to bring the domain back into conformance with the business object. At stages in application control flow specified by the developer, a business object can be instructed to store its changes to the domain. In this third phase, the business object can inspect its state, determine which of the four conditions (no changes were made to the business object, it is a newly created business object, it has been modified after being created from domain information, it has been deleted since being created from domain information) applies, and take the sequence of chosen actions in the domain corresponding to that state to bring the information in the business object and in the corresponding domain information back into conformance.

Only during this third phase may domain objects be updated (i.e., there are side-effects only to the code applied in this phase). Because this violates the functional nature of OQL (which is a query language without side effects), the methods designed for business objects instructing how the domain must be modified in response to business object insertions, modifications, and deletions is not strictly speaking an OQL enhancement. Rather, these are additional methods that can be specified alongside the OQL for each business object.

As the domain is updated, the new data are validated. Attribute-level validations are performed before attributes are modified, thereby guaranteeing that at no time is an attribute set to an invalid value. Additionally, other object-level rules may be optionally applied as desired by the developer of the methods applied in the third phase.

Note that there is complete freedom on the part of the developer of application control code to decide at which points in the application flow to enter each of the three phases for a view. For example, in one extreme case the view can be queried (phase I) once and then interact only with the user interface for an extended period of time while the user works in a single window or windows. If the user decides to abandon work, the view can be instructed to requery the domain cache, effectively discarding all intervening changes. If the user decides to save the work, all intervening changes may be written to the domain in a store command to the view (phase III).

In another extreme case, every change made by the user to any attribute of any business object in the view can be immediately passed through to the domain. The entire view (i.e., all business objects in the view) may be re-synchronized with the domain, or only a single selected business object may be re-synchronized, as requested by application code. This extreme might be preferred if constant error messages from domain objects were desired, or if there were other views that the developer wished to refresh after each attribute were changed.

There is no need to return to phase I (i.e., to query the domain again) after phase III has been performed (i.e., one or more business objects in a view have been re-synchronized with the domain). In many cases, application code may return to interacting with the same business objects (phase II) without re-querying the domain, since synchronization of information has already taken place. Often, the view needs to be explicitly refreshed only after view parameters have been changed or when domain cache information is known to have changed via some other arrangement.

The compiled OQL has also been supplemented to provide an auto-refresh feature. The auto-refresh feature operates as follows. When a business object is built as a result of a query, the query leaves behind a reference to itself in every domain object or collection of domain objects it traverses. In response to a change made to a piece of data in one of the visited domain objects, or the addition or deletion of a domain object to a visited collection of domain objects, the business object is informed of the change before control is returned to the user interface for further user input. If the auto-refresh feature has been chosen by the developer for the query, the query automatically re-queries the domain and updates the data in all of the business objects within it. For example, assume a customer list appears in a first window and an employee list appears in a second window. If a change is made to a name in the employee window, the system will automatically re-query the relevant domain objects and provide an updated customer list in the customer list window. Thus the domain objects enable the auto-refresh function.

The Controller Layer

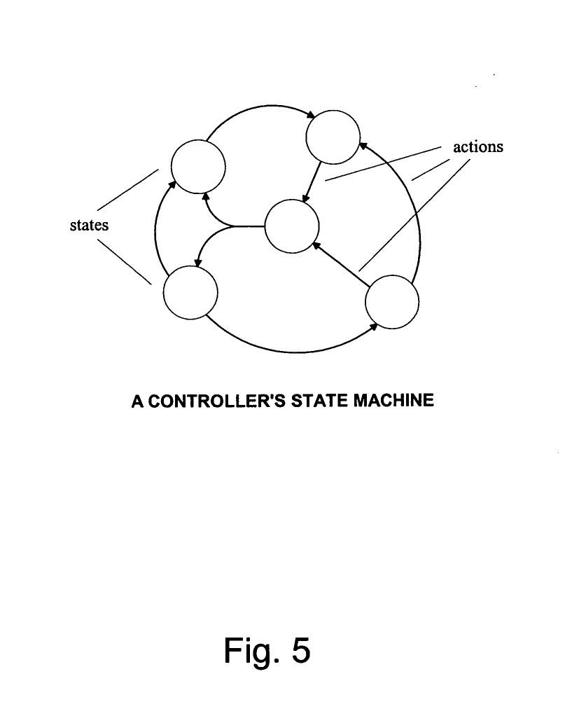

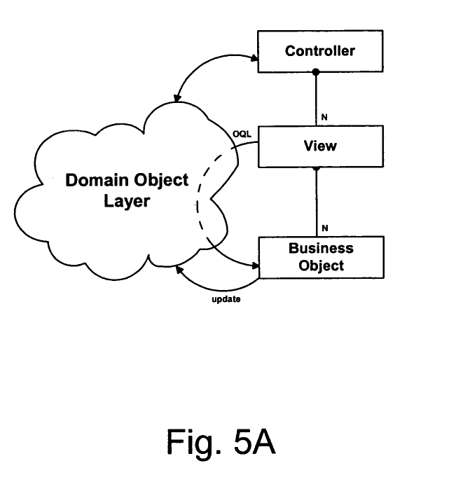

As mentioned earlier, the controller layer is a procedural control mechanism in the form of a state machine that manages the processing of information in the object-oriented business model. Those familiar with the art will know that a state machine resembles a flow chart, modeling the flow of work, but at a more conceptual level. A controller is comprised of two components: states and the transitions between those states. In the present invention, an object known as a “controller” extends this simple state machine model (see FIG. 5). Transitions between states in the controller are called “actions.” These actions manage the processing of the system, calling methods defined on objects in the business-object layer and managing any other required processing. The state of a system is represented by the state of its controller(s), since the state determines which actions and processing are available. The availability of actions in a state can also be constrained by requiring that data in a system satisfy “availability tests.” At the end of an action, the state that is transitioned into is conditionally determined based on the results of the processing during the action. The flow of actions through the state machine implements a procedural control system.

Multiple controllers can be used to decompose the processing of a system into separate, interacting systems. The controllers are organized into groups corresponding to the business application's units of work.

In computer systems, there are two driving forces for the processing in the system. The values that comprise the data used by the system, and input obtained from the user of the system (through some kind of user interface, hereafter referred to as UI). In a system built from multiple components, the processing in one component can also be driven by a signal from another component. For example, in object-oriented system, one object can communicate with another object by calling a method on the other object.

Referring now to FIG. 5A, in the controller model of a system in the current invention, a controller interacts with the data of the system through the business-object layer. On occasion, a controller may also directly check the status of the conceptual cache of database data by interacting with the domain.

A controller interacts with the UI through the adapter layer, which provides a mechanism for displaying data of a system (business objects) in a UI (see the next subsection for more details). The adapter layer frees controllers from having to know any implementation details about a UI. Thus, as well as managing the processing of the application data, a controller also represents an abstract conceptualization of a UI.

In the art, most user interfaces incorporate graphical components (graphical user interface or GUI). In these systems, each panel, dialog, or screen layout in the GUI may correspond to a state in a controller. A screen may have multiple states associated with it if the screen is used for multiple purposes that are not simultaneously available.

Each function in a UI has a corresponding controller representation.

Events in a UI (such as button presses, table selections, mouse events, etc.) are communicated to a controller through the adapter layer. Each event in a UI can be associated with an action in a controller, triggering that action to occur if the action is available in the current state of the controller and the state of the data.

An availability test of an action in a controller represents whether the action can be performed. The corresponding concept in the GUI is represented by the appearance of the GUI widget. An availability test of a controller action returns one of a fixed set of values (for instance, Available, Unavailable, Invisible). These values not only control whether the action can be performed, but also provide an internal conceptual representation of the GUI appearance. The return value of an availability test is translated by the adapter layer to behavior in the GUI widget associated with the action. For instance, the widget can be automatically enabled, disabled, or made invisible. Additional UI functionality, such as confirmation that must take place from a user before performing an action (for instance, “Do you really want to exit?”) can be modeled in the controller through a message-management system.

As the process manager, a controller also provides the mechanism through which application data is made available to a UI. The adapter layer interfaces with business objects managed by the controller, associating them with UI elements for a particular display appearance. Events from the UI element associated with a business object can be filtered back to the business object through the adapter, usually by triggering a controller action that manages the processing on that business object by calling the methods on the object itself. In this manner, the process control model interacts with the object-oriented business layer.

As the process manager, a controller also must manage the UI. A controller can perform such management by signaling events, which can be listened for in the UI.

The Adapter Layer

The adapter layer interacts between a user interface (UI) and the business-object and controller layers. The adapter layer isolates all knowledge of UI implementation details from business objects and controllers. Furthermore, the adapter layer frees this invention from being tied to any particular UI, as is evidenced by the existence of different families of adapters that interact with different UI implementations. In particular, there currently exists a family of Swing adapters that provide an interface between Sun's Java-SwingÔ components and this invention. Likewise, there currently exists a family of markup adapters that provide an interface between Web Pages (HTML, JSP) and this invention. As new display technologies become prevalent, new families of adapters can be created for them, and the isolation of the core domain, business objects, and controllers from any knowledge of UI implementation is maintained.

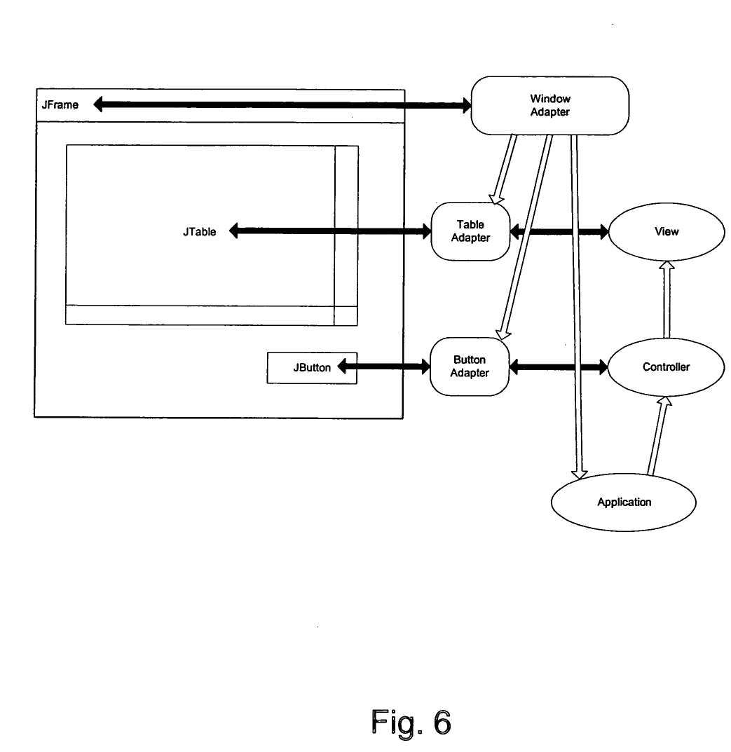

Referring now to FIG. 6, one possible arrangement configured to display and manipulate business objects in a Java-Swing-based GUI is shown. In this diagram, a table adapter associates a view managing a collection of business objects with a Java Swing table widget called a JTable. The association is made in a graphical development environment (such as Visual Age for Java); the adapter, views, and business objects are available as design elements in the development environment because they've been encapsulated as Java beans. Because the Java code implementing the adapter has been produced with the necessary interface, the JTable can interact with the view (through the adapter) to present the business objects row by row in the table. Furthermore, each cell of the JTable can be made to present choice sets in a combo box when the cursor has been place in the cell and the value has a choice set associated with it. Also, the information presented by the business objects can be used to change colors and fonts or change the data format in other ways to show special emphasis of certain values as signaled by the business object.

There are many adapters corresponding to the different components being adapted. In the standard view-model-control paradigm by which many components are designed, the adapter becomes the model. For example:

1. For a (Java-SwingÔ) JTextComponent the (Swing) adapter is the Document.

2. For a JComboBox the adapter is the ComboBoxModel.

3. For a JList the adapter is the ListModel.

4. For a JTable the adapter is the TableModel and ListSelectionModel.

5. For a JTree the adapter is the TreeModel and TreeSelectionModel.

By becoming the model, the adapter is responsible for providing all data content to the component; the text inside a text field or label is retrieved from the business object attribute to which the adapter is routed; items in a drop down or list box are retrieved as a set of enumerated possible values for the respective business object attribute

The adapter makes sure that data is synchronized between the component being adapted and the business object to which the adapter is routed. Whenever the user changes the data through typing or mouse clicks, the adapter notifies the business object of the change. Likewise, whenever the business object attributes change, all applicable adapters are notified of the change, which in turn, cause the GUI component to repaint and display the changed content.

In cases where the user enters text, or clicks on a checkbox or radio button, the adapter is responsible for translating the user input into an object whose type is consistent with the particular business object attribute that is being displayed.

Through contained format class instances, the adapter also is responsible for ensuring that the data in the component conforms to a configured format. This includes internationalized representations of dates and decimals, as well as masked string entry.

Adapters can also: (1) supply (localized) possible values to drop-downs, (2) supply (localized) “fly-over” hints for buttons and other components, and (3) highlight or give focus to interface components in response to messages from the domain.

In addition to synchronization of data between component and business object, an adapter can also affect the behavior and appearance of a component. In most cases, the adapter can enable or disable the component, which may cause the component to appear grayed out. The adapter can also change the font colors, border and/or icon that are used to render the component, via the “accent” mechanism of business objects.

Finally, adapters listen for and intercept various events that are raised by their source components, and translate these events into common adapter events. For example, a “dataEntryComplete” event is raised whenever the user tabs out of a text field, or hits enter within the field—the focusLost and actionPerformed events are both received and translated into a dataEntryComplete event.

Adapter events are usually associated with controller actions, which cause the controller to transition from one state to another.

Having described the preferred embodiments of the invention, it will now become apparent to one of skill in the art that other embodiments incorporating their concepts may be used. It is felt therefore that these embodiments should not be limited to disclosed embodiments but rather should be limited only by the spirit and scope of the appended claims. All references cited herein are hereby incorporated herein by reference in their entirety.

What is claimed is:

1. An information processing system, comprising:
a data store configured to store data;
a persistence layer configured to communicate with the data store;
a domain layer, the domain layer including at least one domain object, each of the domain objects configured to communicate with the data store via the persistence layer and to store data retrieved from the data store; and
a business object layer, the business object layer including at least one business object, each business object configured to communicate with at least one of the domain objects and to retrieve data therefrom.

2. The information processing system according to claim 1, wherein the persistence layer includes at least one access object configured to retrieve data from the data store and at least one maintenance object adapted to store data in the data store.

3. The information processing system according to claim 1, further comprising a user interface layer, the user interface layer including at least one user interface configure to provide an interface for a human user to interact with the information processing system.

4. The information processing system according to claim 3, further comprising an adapter layer, the user interface layer configured to communicate with the business object layer via the adapter layer.

5. The information processing system according to claim 1, wherein the domain objects are configured to perform at least one of data validation, computation to calculate derived information and data manipulation.

6. The information processing system according to claim 1, wherein the domain layer includes a messaging mechanism.

7. The information processing system according to claim 6, further comprising a messaging queue, the messaging mechanism posting a message to the message queue.

8. The information processing system according to claim 1, further comprising a controller layer, the controller layer configured to control communication between the data store and the domain layer and between the business-object layer and the domain layer.

9. The information processing system according to claim 1, wherein the information processing system comprises a plurality of business objects defining a business object hierarchy.

10. The information processing system according to claim 1, wherein the data stored in each of the domain objects is unique to the respective domain object.

11. The information processing system according to claim 1, wherein the data stored in each of the domain objects is a subset of the data stored in the data store.

12. The information processing system according to claim 1, wherein the data stored in each business object is refreshed in response to a change of data stored in the domain objects.

13. The information processing system according to claim 1, wherein the business objects are configured to retrieve data from the data store solely via the domain objects.

14. The information processing system according to claim 1, wherein the domain layer is configured to provide a transaction mechanism for integrating data in the data store.

15. The information processing system according to claim 1, wherein the persistence layer is configured to manage creation of the domain objects from data stored in the data store and to update the data store with data stored in the domain objects.

16. The information processing system according to claim 1, wherein the business objects are further configured to communicate with the data store and to retrieve data therefrom.

17. The information processing system according to claim 1, further comprising at least one view object, the business objects being further configured to communicate with the at least one view object and to retrieve data therefrom.

18. An information processing system, comprising method for processing data stored in a data store, the method comprising the steps of:
(a) retrieving at least a portion of the data from the data store via a persistence layer;
(b) storing the data retrieved in the retrieving step (a) in at least one domain object;
(c) retrieving at least a portion of the data stored in the domain object;
(d) storing the data retrieved in the retrieving step (c) in at least one business object; and
(e) processing the data stored in the business object.

19. The information processing system according to claim 18, wherein the method further comprises the step of providing at least one user interface allowing human user interaction.

20. The information processing system according to claim 18, wherein the method further comprises at least one of the substeps of validating the data stored in the domain objects, calculating derived information from data stored in the domain objects and manipulating data stored in the domain objects.

21. The information processing system according to claim 18, wherein the method further comprises the step of posting a message from the domain object to a message queue.

22. The information processing system according to claim 18, wherein the method further comprises the step of anticipating a future retrieval of data to be retrieved in the retrieving step (a).

23. The information processing system according to claim 22, wherein the method further comprises the step of pre-fetching the anticipated data.

24. The information processing system according to claim 18, wherein the method further comprises the step of defining a hierarchy of a plurality of business objects.

25. The information processing system according to claim 18, wherein the storing step (b) comprises the step of storing unique data to each domain object.

26. The information processing system according to claim 18, wherein the data stored in the storing step (b) is a subset of the data stored in the data store.

27. The information processing system according to claim 18, wherein the method further comprises the step of refreshing the data stored in the business object in response to a change in the data stored in the domain objects.

28. A method for processing data stored in a data store, the method comprising the steps of:
(a) retrieving at least a portion of the data from the data store via a persistence layer;
(b) storing the data retrieved in the retrieving step (a) in at least one domain object;
(c) retrieving at least a portion of the data stored in the domain object;
(d) storing the data retrieved in the retrieving step (c) in at least one business object; and
(e) processing the data stored in the business object.

29. The method according to claim 28, further comprising the step of providing at least one user interface allowing human user interaction.

30. The method according to claim 28, further comprising at least one of the substeps of validating the data stored in the domain objects, calculating derived information from data stored in the domain objects and manipulating data stored in the domain objects.

31. The method according to claim 28, further comprising the step of posting a message from the domain object to a message queue.

32. The method according to claim 28, further comprising the step of anticipating a future retrieval of data to be retrieved in the retrieving step (a).

33. The method according to claim 32, further comprising the step of pre-fetching the anticipated data.

34. The method according to claim 28, further comprising the step of defining a hierarchy of a plurality of business objects.

35. The method according to claim 28, wherein the storing step (b) comprises the step of storing unique data to each domain object.

36. The method according to claim 28, wherein the data stored in the storing step (b) is a subset of the data stored in the data store.

37. The method according to claim 28, further comprising the step of refreshing the data stored in the business object in response to a change in the data stored in the domain objects.

38. A computer-readable storing medium storing a set of instructions, the set of instructions capable of being executed by a processor arrangement to implement a method for processing data stored in a data store, the method comprising the steps of:
(a) retrieving at least a portion of the data from the data store via a persistence layer;
(b) storing the data retrieved in the retrieving step (a) in at least one domain object;
(c) retrieving at least a portion of the data stored in the domain object;
(d) storing the data retrieved in the retrieving step (c) in at least one business object; and
(e) processing the data stored in the business object.

39. The computer-readable storing medium according to claim 38, wherein the method further comprises the step of providing at least one user interface allowing human user interaction.

40. The computer-readable storing medium according to claim 38, wherein the method further comprises at least one of the substeps of validating the data stored in the domain objects, calculating derived information from data stored in the domain objects and manipulating data stored in the domain objects.

41. The computer-readable storing medium according to claim 38, wherein the method further comprises the step of posting a message from the domain object to a message queue.

42. The computer-readable storing medium according to claim 38, wherein the method further comprises the step of anticipating a future retrieval of data to be retrieved in the retrieving step (a).

43. The computer-readable storing medium according to claim 42, wherein the method further comprises the step of pre-fetching the anticipated data.

44. The computer-readable storing medium according to claim 38, wherein the method further comprises the step of defining a hierarchy of a plurality of business objects.

45. The computer-readable storing medium according to claim 38, wherein the storing step (b) comprises the step of storing unique data to each domain object.

46. The computer-readable storing medium according to claim 38, wherein the data stored in the storing step (b) is a subset of the data stored in the data store.

47. The computer-readable storing medium according to claim 38, wherein the method further comprises the step of refreshing the data stored in the business object in response to a change in the data stored in the domain objects.
